(19) United States
(12) Patent Application Publication
(10) Pub. No.: US 2021/0324977 A1
(43) Pub. Date: Oct. 21, 2021

(54) PIPING FOR ULTRA-PURE WATER AND MULTI-LAYER TUBE

(71) Applicant: SEKISUI CHEMICAL CO., LTD., Osaka (JP)

(72) Inventors: Hiroaki KONDOU, Kyoto (JP); Kouzou MAKINO, Kyoto (JP); Ayaka KITAGAWA, Kyoto (JP); Shintarou UMEYAMA, Kyoto (JP)

(73) Assignee: SEKISUI CHEMICAL CO., LTD., Osaka (JP)

(21) Appl. No.: 17/285,593

(22) PCT Filed: Oct. 17, 2019
(86) PCT No.: PCT/JP2019/040913

§ 371 Date: Apr. 15, 2021

(30) Foreign Application Priority Data
Oct. 17, 2018 (JP) 2018-195925

(51) Int. Cl. F16L 9/133; F16L 9/12

(52) U.S. Cl. CPC F16L 9/133; B32B 27/18; F16L 9/121

(57) ABSTRACT

Provided is piping for ultra-pure water from which the amount of calcium leaching can be suppressed to an extent that satisfies the quality required for ultra-pure water, and which can be produced so as to be provided with mechanical properties.

[Solution] This piping for ultra-pure water is used for conveying ultra-pure water and includes a first polyolefin-based resin layer constituting the innermost layer, and a second polyolefin-based resin layer disposed on the outer side of the first polyolefin-based resin layer, wherein the calcium concentration within the first polyolefin-based resin layer is 10 ppm or lower, and the calcium concentration within the second polyolefin-based resin layer is between 20 ppm and 200 ppm inclusive. With this constitution, the amount of calcium leaching can be suppressed to an extent that satisfies the quality required for ultra-pure water, and the piping can be produced so as to be provided with mechanical properties.

### TECHNICAL FIELD

The present invention relates to a piping for ultra-pure water and a multi-layer tube. More specifically, the present invention relates to a polyotefin-based resin tube and a multi-layer tube used as a piping for ultra-pure water.

### BACKGROUND ART

Conventionally, in the manufacture of precision devices such as semiconductor devices or liquid crystal display devices, ultra-pure water purified to extremely high purity has been used in a wet process such as cleaning. If metal ions or the like are present at a predetermined concentration or higher in water, a metal is adsorbed on a wafer surface or the like, which adversely affects the quality of the precision devices. Therefore, impurities in the ultra-pure water are strictly restricted.

The mixing of the impurities into the ultra-pure water also occurs in a piping which constitutes an ultra-pure water transportation line. As the material of the piping, a metal such as stainless steel having excellent gas barrier property has been possibly used, but a resin is said to be preferably used in consideration of the influence of the leaching of the metal from the piping.

As the resin used as the material for the piping for ultra-pure water, a fluororesin is used, which is chemically inert, has gas barrier property, and has extremely low leaching property into ultra-pure water. For example, Patent Document 1 discloses, as a piping for use in a semiconductor manufacturing device and a liquid crystal manufacturing device and the like, a fluororesin double tube including two laminated fluororesin layers. The fluororesin double tube includes an inner layer tube and an outer layer tube. The inner layer tube is formed of a fluororesin having excellent corrosion resistance and chemical resistance (for example, a tetrafluoroethylene-perfluoroalkylvinylether copolymer (PFA), a tetrafluoroethylene-hexafluoropropylene copolymer (FEP), or a tetrafluoroethylene-ethylene copolymer (ETFE)). The outer layer tube is formed of a fluororesin capable of suppressing gas permeation (for example, polyvinylidene-fluoride (PVDF)). Patent Document 2 discloses a multi-layer tube for piping ultra-pure water, which includes a first resin layer made of a fluororesin and being in contact with ultra-pure water, and a second resin layer made of a gas-impermeable resin and provided on the outer peripheral surface of the first resin layer. Furthermore, a third resin layer for protecting the second resin layer is provided on the outer peripheral surface of the second resin layer, and polyethylene is used as the third resin layer.

Among resins used as materials for the piping for ultra-pure water, polyvinylidene fluoride (PVDF) is used in all pipings put to practical use as a piping in an ultra-pure water manufacturing device and a piping for conveying ultra-pure water from the ultra-pure water manufacturing device to use points in the semiconductor field, and becomes a technical standard in the piping for ultra-pure water.

Recently, as the degree of integration of semiconductor chips increases, circuit patterns become finer and finer, and are more susceptible to low-level impurities. Therefore, water quality required for the ultra-pure water becomes stricter. For example, standards for the quality and the like of the ultra-pure water used in semiconductor manufacture are published as SEMI F75, and updated every two years.

### PRIOR ART DOCUMENTS

### Patent Documents

Patent Document 1: Japanese Patent Laid-open Publication No. 2004-299808

Patent Document 2: Japanese Patent Laid-open Publication No. 2010-234576

### SUMMARY OF THE INVENTION

### Problems to be Solved by the Invention

A piping made of a fluororesin such as PVDF has some disadvantages in terms of workability and cost as compared with other general piping. However, in the background of stricter water quality required for the ultra-pure water, the piping made of a fluororesin is the only option as the piping which satisfies the required water quality, and has outstanding performance which more than makes up for workability and cost and is strongly supported.

Contrary to this background, the present inventors dared to focus attention on the substitution of the material for the piping for ultra-pure water. For example, as a general piping material, a polyolefin-based resin having excellent workability and cost is used. However, the polyolefin-based resin which is widely used as the piping material is synthesized by polymerization using a chlorine-based catalyst, which makes it necessary to mix a neutralizing agent such as calcium stearate or hydrocalcite in order to neutralize a catalyst residue after polymerization. For this reason, the polyolefin-based resin tube causes the leaching of calcium derived from the neutralizing agent into water to be conveyed. The leaching level of calcium is far inferior to the water quality required for the ultra-pure water.

The present inventors surprisingly found that a material in which the amount of the neutralizing agent added to the catalyst in the polyolefin-based resin is extremely smaller than the original amount for neutralizing the catalyst residue is used as the material for the polyolefin-based resin tube, whereby the leaching amount of calcium can be drastically reduced to the extent which could be heretofore achieved only by the piping made of a fluororesin such as PVDF, and the influence of the catalyst residue is not as problematic as the leaching of calcium in the polyolefin-based resin on the inner wall side of the piping which is in contact with ultra-pure water. Meanwhile, in the polyolefin-based resin on the outer wall side of the piping, the catalyst residue maintains its activity, which accelerates oxidative deterioration. As a result, the present inventors also faced a new challenge causing unsatisfactory mechanical strength to be provided for the piping (specifically, long-term durability against internal pressure).

That is, the substitution of the material of the piping for ultra-pure water with the polyolefin-based resin has been found to have peculiar problems that both the suppression of the leaching amount of calcium to an extent which satisfies the quality required for ultra-pure water and the production of a piping having mechanical properties cannot be achieved.

In view of the above problems, it is an object of the present invention to provide a piping for ultra-pure water which is made of a polyolefin-based resin, can suppress the leaching amount of calcium to an extent satisfying the quality required for ultra-pure water, and can be produced so as to be provided with mechanical properties (specifically, refer to long-term durability against internal pressure, and hereinafter may be simply described as strength).

### Means for Solving the Problem

As a result of diligent studies, the present inventors have found that a polyolefin-based resin tube has a multi-layer structure, and polyolefin-based resin materials having calcium contents designed to be within specific ranges are used as materials for an innermost polyolefin-based resin layer and a polyolefin-based resin layer disposed on the outer side of the innermost polyolefin-based resin layer, whereby the leaching amount of calcium can be suppressed to an extent which satisfies the quality required for ultra-pure water, and a piping can be produced so as to be provided with mechanical properties. The present invention has been completed by further studying based on this finding. That is, the present invention provides the inventions of the following aspects.

Item 1.

A piping for ultra-pure water used for conveying ultra-pure water, the piping for ultra-pure water including:

a first polyolefin-based resin layer constituting an innermost layer; and

a second polyolefin-based resin layer disposed on an outer side of the first polyolefin-based resin layer,

wherein a calcium concentration in a polyolefin-based resin composition used for the first polyolefin-based resin layer is 10 ppm or less, and

a calcium concentration in a polyolefin-based resin composition used for the second polyolefin-based resin layer is 20 ppm or more and 20 ppm or less.

Item 2.

The piping for ultra-pure water according to Item 1, wherein the polyolefin-based resin composition used for the first polyolefin-based resin layer is a polyethylene-based resin composition.

Item 3.

The piping for ultra-pure water according to Item 2, wherein the polyethylene-based resin is high density polyethylene.

Item 4.

The piping for ultra-pure water according to any one of Items 1 to 3, wherein a molecular weight distribution Mw/Mn in the first polyolefin-based resin layer is 2 to 20.

Item 5.

The piping for ultra-pure water according to any one of Items 1 to 4, wherein a thickness of the first polyolefin-based resin layer is 0.8 mm or more.

Item 6.

The piping for ultra-pure water according to any one of Items 1 to 5, wherein a thickness of the first polyolefin-based resin layer is 2.0 mm or less.

Item 7.

The piping for ultra-pure water according to any one of Items 1 to 6, wherein the piping for ultra-pure water has SDR of 17 or less.

Item 8.

The piping for ultra-pure water according to any one of Items 1 to 7, wherein a weight average molecular weight of the polyolefin-based resin used for the second polyolefin-based resin layer is 1.5 to 4 times a weight average molecular weight of the polyolefin-based resin used for the first polyolefin-based resin, and a molecular weight distribution Mw/Mn in the second polyolefin-based resin layer is 20 to 40.

Item 9.

The piping for ultra-pure water according to any one of Items 1 to 8, further including a gas barrier layer provided on an outer side of the second polyolefin-based resin layer.

Item 10.

The piping for ultra-pure water according to any one of Items 1 to 9, wherein the ultra-pure water is used in a wet treatment process of a semiconductor element or a liquid crystal.

Item 11.

The piping for ultra-pure water according to any one of Items 1 to 9, wherein the ultra-pure water is used in a wet treatment process of a semiconductor element having a minimum line width of 65 nm or less.

Item 12.

A multi-layer tube including:

a first polyolefin-based resin layer constituting an innermost layer; and

a second polyolefin-based resin layer disposed on an outer side of the first polyolefin-based resin layer,

wherein a calcium concentration in a polyolefin-based resin composition used for the first polyolefin-based resin layer is 10 ppm or less, and

a calcium concentration in a polyolefin-based resin composition used for the second polyolefin-based resin layer is 20 ppm or more and 200 ppm or less.

### BRIEF DESCRIPTION OF THE DRAWING

FIG. 1 is a schematic cross-sectional view showing an example of a piping for ultra-pure water of the present invention.

FIG. 2 is a schematic cross-sectional view showing another example of the piping for ultra-pure water of the present invention.

FIG. 3 is a schematic cross-sectional view showing still another example of the piping for ultra-pure water of the present invention.

### EMBODIMENTS OF THE INVENTION

[1. Layer Constitution of Piping]

A piping for ultra-pure water or a multi-layer tube of the present invention includes a first polyolefin-based resin layer constituting an innermost layer and a second polyolefin-based resin layer disposed on an outer side of the first polyolefin-based resin layer. Hereinafter, the piping for ultra-pure water or the multi-layer tube of the present invention will be described in detail with reference to examples of the pipings for ultra-pure water shown in FIGS. 1 to 3. In the present specification, a numerical range indicated by “to” includes at both end values thereof. For example, the notation of 0.5 to 3.0 mm means 0.5 mm or more and 3.0 mm or less.

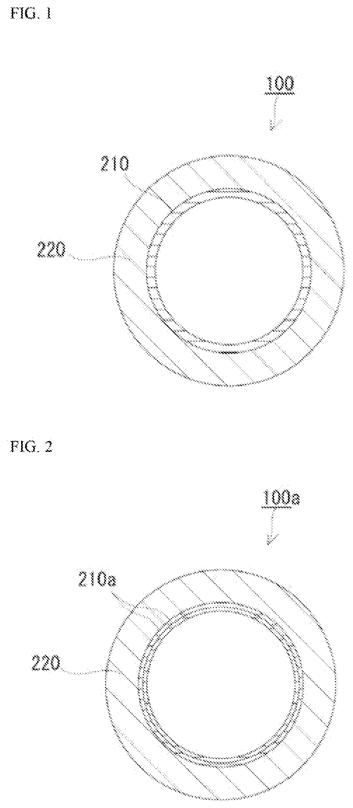

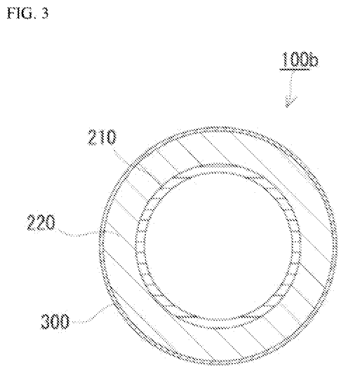

A piping for ultra-pure water 100 shown in FIG. 1 includes a first polyolefin-based resin layer 210 and a second polyolefin-based resin layer 220. The first polyolefin-based resin layer 210 constitutes the innermost layer of the piping for ultra-pure water 100, and the second polyolefin-based resin layer 220 is laminated in contact with the first polyolefin-based resin layer 210. A piping for ultra-pure water 100a shown in FIG. 2 includes a first polyolefin-based resin layer 210a and a second polyolefin-based resin layer 220. The first polyolefin-based resin layer 210a has a multi-layer structure. Although not shown, the piping for ultra-pure water of the present invention may include a first polyolefin-based resin layer having a single-layer structure and a second polyolefin-based resin layer having a multi-layer structure; may include a first polyolefin-based resin layer having a multi-layer structure and a second polyolefin-based resin layer having a multi-layer structure; or may include other layer between the first polyolefin-based resin layer 210 and the second polyolefin-based resin layer 220. A piping for ultra-pure water 100b shown in FIG. 3 includes a first polyolefin-based resin layer 210, a second polyolefin-based resin layer 220, and a gas barrier layer 30). The gas barrier layer 300 may be laminated on the outer side of the second polyolefin-based resin layer 220. The gas barrier layer 30 may constitute the outermost layer of the piping for ultra-pure water 100b, or other layer may be provided on the outer side of the gas barrier layer 30).

[2. First Polyolefin-Based Resin Layer]

A polyolefin-based resin used for the first polyolefin-based resin layer is not particularly limited, and may be a polymer containing monomer units derived from an olefin. Examples thereof include polyethylene-based resins, ethylene-carboxylic acid alkenyl ester copolymer resins, ethylene-α-olefin copolymer resins, polypropylene-based resins, polybutene-based resins, and poly(4-methyl-1-pentene)-based resins. One of these polyolefin-based resins may be used alone, or two or more thereof may be used in combination. Among these polyolefin-based resins, polyethylene-based resins and polypropylene-based resins are preferable from the viewpoint of improving the strength and the like of the piping for ultra-pure water. Among the polyethylene-based resins and the polypropylene-based resins, the polyethylene-based resins are preferable from the viewpoint of suppressing the content of low molecular weight components to suppress the leaching of organic components into ultra-pure water, and the polypropylene-based resins are preferable from the viewpoint of more easily obtaining the surface smoothness of the first polyolefin-based resin layer constituting the innermost layer.

The polyethylene-based resins are not particularly limited, and examples thereof include low density polyethylene (LDPE), linear low density polyethylene (LLDPE), medium density polyethylene (MDPE), and high density polyethylene (HDPE). Among these, the high density polyethylene (HDPE) is preferable from the viewpoint of suppressing the leaching of the organic components into the ultra-pure water.

Examples of carboxylic acid alkenyl esters in the ethylene-carboxylic acid alkenyl ester copolymer resins include vinyl acetate, vinyl propionate, vinyl butyrate, isopropenyl acetate, and allyl acetate, and vinyl acetate is preferable.

Examples of the ethylene-α-olefin copolymer include a copolymer obtained by copolymerizing an α-olefin such as propylene, 1-butene, 1-pentene, 1-hexene, 4-methyl-1-pentene, or 1-octene as a copolymerization component with ethylene in a ratio of about several mol %.

Examples of the polypropylene-based resins include homopolypropylene, block polypropylene, and random polypropylene. Typical examples of a copolymerization component in the block polypropylene and the random polypropylene include ethylene. Among these, the random polypropylene is preferable from the viewpoint of exhibiting the rigidity and strength and the like of the piping for ultra-pure water in a well-balanced manner. Examples of the polybutene-based resin include polybutene-1.

The molecular weight of the polyolefin-based resin used for the first polyolefin-based resin layer is not particularly limited, and the weight average molecular weight Mw is, for example, 1×10⁵ to 7×10⁵. From the viewpoint of suppressing the leaching of the organic components into the ultra-pure water and obtaining surface smoothness, the weight average molecular weight Mw is, for example, 1×10⁵ to 5×10⁵, and preferably 2×10⁵ to 3×10³. The weight average molecular weight Mw is a value measured in terms of polystyrene by gel permeation chromatograph measurement.

The molecular weight distribution (Mw/Mn) of the polyolefin-based resin used for the first polyolefin-based resin layer is, for example, 2 or more, and preferably 3 or more, from the viewpoint of processability during tube formation. Furthermore, from the viewpoint of also suppressing the leaching of the organic components into the ultra-pure water, the molecular weight distribution (Mw/Mn) is, for example, 30 or less, preferably 20 or less, more preferably 15 or less, still more preferably 10 or less, yet still more preferably 7 or less, and particularly preferably 6 or less. Therefore, the specific range of the molecular weight distribution (Mw/Mn) of the polyolefin-based resin used for the first polyolefin-based resin layer is 2 to 30, 2 to 20, 2 to 15, 2 to 10, 2 to 7, 2 to 6. 3 to 30, 3 to 20, 3 to 15, 3 to 10, 3 to 7, and 3 to 6. The molecular weight distribution (Mw/Mn) is a value (Mw/Mn) obtained by obtaining a weight average molecular weight (Mw) and a number average molecular weight (Mn) in terms of polystyrene according to gel permeation chromatograph measurement, and dividing Mw by Mn.

A calcium concentration in the polyolefin-based resin composition used for the first polyolefin-based resin layer is 10 ppm or less. If the calcium concentration exceeds 10 ppm, the amount of calcium leaching into the ultra-pure water becomes excessive, which makes it impossible to satisfy the water quality required for the ultra-pure water. From the viewpoint of further suppressing the amount of calcium leaching into the ultra-pure water, the calcium concentration in the polyolefin-based resin composition used for the first polyolefin-based resin layer is preferably 5 ppm or less, more preferably 3 ppm or less, still more preferably 1 ppm or less, and yet still more preferably 0.9 ppm or less. The calcium concentration in the polyolefin-based resin composition used for the first polyolefin-based resin layer is most preferably 0 ppm in view of the fact that, as the calcium concentration is lower, the amount of calcium leaching into the ultra-pure water is smaller. However, in a case where the mixing of a small amount of calcium is unavoidable such as a case where a slight amount of neutralizing agent is used even when a chlorine-based catalyst such as a Cheegler-Natta catalyst is used for the synthesis of the polyolefin-based resin used for the first polyolefin-based resin layer, the calcium concentration in the polyolefin-based resin composition used for the first polyolefin-based resin layer may be, for example, 0.3 ppm or more, 0.5 ppm or more, or 0.7 ppm or more. Therefore, the specific range of the calcium concentration in the polyolefin-based resin composition used for the first polyolefin-based resin layer is 0 to 10 ppm, 0.3 to 10 ppm, 0.5 to 10 ppm, 0.7 to 10 ppm, 0 to 5 ppm, 0.3 to 5 ppm, 0.5 to 5 ppm, 0.7 to 5 ppm, 0 to 3 ppm, 0.3 to 3 ppm, 0.5 to 3 ppm, 0.7 to 3 ppm, 0 to 1 ppm, 0.3 to 1 ppm, 0.5 to 1 ppm, 0.7 to 1 ppm, 0 to 0.9 ppm, 0.3 to 0.9 ppm, 0.5 to 0.9 ppm, and 0.7 to 0.9 ppm.

When the first polyolefin-based resin layer 210a is multi-layered as in, for example, the piping for ultra-pure water 100a, the calcium concentration in the polyolefin-based resin layer constituting the innermost layer of the multi-layered first polyolefin-based resin layer 210a may be designed to be lower than that of the polyolefin-based resin constituting the other layer of the first polyolefin-based resin layer 210a.

The piping for ultra-pure water is provided with a degassing device for removing oxygen, which eliminates the need for an antioxidant in the first polyolefin-based resin layer. The antioxidant is not contained in the polyolefin-based resin composition used for the first polyolefin-based resin layer, whereby the leaching of the organic components into the ultra-pure water can be further suppressed. Examples of the antioxidant include phenol-based antioxidants, phosphorus-based antioxidants, sulfur-based antioxidants, aromatic amine-based antioxidants, and lactone-based antioxidants.

The thickness of the first polyolefin-based resin layer is not particularly limited, and can be appropriately determined, for example, within the range of 0.5 to 3.0 mm in consideration of a calcium concentration in the polyolefin-based resin composition used for the second polyolefin-based resin layer, and the overall strength of the piping for ultra-pure water, and the like. From the viewpoint of blocking the leaching of calcium into the ultra-pure water due to the migration of calcium contained in the second polyolefin-based resin layer, the lower limit of the thickness of the first polyolefin-based resin layer is preferably 0.8 mm or more, and more preferably 0.9 mm or more. From the viewpoint of suppressing the influence of the lack of the strength of the first polyolefin-based resin layer itself in the entire piping for ultra-pure water, the upper limit of the thickness of the first polyolefin-based resin layer is preferably 2.0 mm or less, more preferably 1.5 mm or less, and still more preferably 1.2 m or less. Therefore, the specific range of the thickness of the first polyolefin-based resin layer is 0.5 to 3.0 mm, 0.5 to 2.0 mm, 0.5 to 1.5 mm, 0.5 to 1.2 mm, 0.8 to 3.0 mm, 0.8 to 2.0 mm, 0.8 to 1.5 mm, 0.8 to 1.2 mm, 0.9 to 3.0 mm, 0.9 to 2.0 mm, 0.9 to 1.5 mm, and 0.9 to 1.2 mm.

Furthermore, regarding the thickness of the above-described first polyolefin-based resin layer, SDR (reference outer diameter/minimum wall thickness) can be adjusted to, for example, 7 or more, preferably 9.5 or more, and more preferably 10 or more, from the viewpoint of being likely to make the inner diameter of the tube sufficient for the outer diameter to secure the amount of the ultra-pure water to be conveyed. Regarding the thickness of the above-described first polyolefin-based resin layer, the SDR (reference outer diameter/minimum wall thickness) can be adjusted to, for example, 20 or less, preferably 17 or less, more preferably 15 or less, and still more preferably 13 or less, from the viewpoint of securing the thickness of the second polyolefin-based resin layer to compensate for the lack of the strength of the first polyolefin-based resin layer itself, thereby providing more preferable strength the entire piping for ultra-pure water suitable for practical use. Therefore, the specific range of the SDR (reference outer diameter/minimum wall thickness) is 7 to 20, 7 to 17, 7 to 15, 7 to 13, 9.5 to 20, 9.5 to 17, 9.5 to 15, 9.5 to 13, 10 to 20, 10 to 17, 10 to 15, and 10 to 13.

[3. Second Polyolefin-Based Resin Layer]

A polyolefin-based resin used for the second polyolefin-based resin layer is not particularly limited, and can be appropriately selected from those listed as the polyolefin-based resin used for the above-described first polyolefin-based resin layer. Among the above-described polyolefin-based resins, high density polyethylene (HDPE) is preferable from the viewpoint of suppressing the leaching of the low molecular weight components and/or from the viewpoint of durability when the piping is cleaned with a chemical. The polyolefin-based resin used for the second polyolefin-based resin layer may be the same type as or different from the polyolefin-based resin used for the first polyolefin-based resin layer, but when both the layers are laminated in contact with each other, the polyolefin-based resins are more preferably the same type from the viewpoint of improving the adhesion between both the layers to exhibit preferable strength.

The molecular weight of the polyolefin-based resin used for the second polyolefin-based resin layer is not particularly limited, but it is preferably more than the molecular weight of the polyolefin-based resin used for the first polyolefin-based resin layer from the viewpoint of strength. For example, the average molecular weight Mw is 5×10⁵ to 8×10⁵, preferably 5.5×10⁵ to 8×10⁵, and more preferably 6×10⁵ to 8×10⁵. The weight average molecular weight of the polyolefin-based resin used for the second polyolefin-based resin layer is 1.5 to 4 times, and preferably 2 to 4 times the weight average molecular weight of the polyolefin-based resin used for the first polyolefin-based resin layer, from the viewpoint of strength.

The molecular weight distribution (Mw/Mn) of the polyolefin-based resin constituting the second polyolefin-based resin layer is not particularly limited, and is, for example, 20 to 40. The molecular weight distribution (Mw/Mn) of the polyolefin-based resin used for the second polyolefin-based resin layer is particularly preferably 20 or more when the weight average molecular weight of the polyolefin-based resin used for the second polyolefin-based resin layer is 1.5 to 4 times, and preferably 2 to 4 times the weight average molecular weight of the polyolefin-based resin constituting the first polyolefin-based resin. That is, the molecular weight distribution (Mw/Mn) of the polyolefin-based resin used for the second polyolefin-based resin layer is preferably 20 or more, and more preferably 22 or more, from the viewpoint of sufficiently securing the low molecular weight components at the layer interface with the first polyolefin-based resin layer (that is, sufficiently securing the overlapping portion of the molecular weight distribution between both the layers) to improve the adhesion, thereby obtaining good strength. The molecular weight distribution (Mw/Mn) of the polyolefin-based resin used for the second polyolefin-based resin layer is preferably 40 or less, more preferably 30 or less, and still more preferably 25 or less, from the viewpoint of obtaining the strength of the second polyolefin-based resin layer itself. Therefore, the specific range of the molecular weight distribution (Mw/Mn) of the polyolefin-based resin used for the second polyolefin-based resin layer is 20 to 40, 22 to 30, 22 to 40, 22 to 30, 25 to 40, and 25 to 30.

A calcium concentration in the polyolefin-based resin composition used for the second polyolefin-based resin layer is 20 to 200 ppm. When the calcium concentration in the polyolefin-based resin composition used for the second polyolefin-based resin layer is less than 20 ppm, the weak strength of the first polyolefin-based resin layer itself is not compensated, so that the strength of the entire piping for ultra-pure water suitable for practical use cannot be provided. When the calcium concentration in the polyolefin-based resin composition used for the second polyolefin-based resin layer exceeds 200 ppm, the contained calcium itself becomes a foreign substance, and is apt to become a starting point of breakage, so that, after all, strength suitable for practical use cannot be provided.

From the viewpoint of compensating for the lack of the strength of the first polyolefin-based resin layer itself to provide more preferable strength of the entire piping for ultra-pure water, the lower limit of the calcium concentration in the polyolefin-based resin composition used for the second polyolefin-based resin layer is preferably 30 ppm or more, more preferably 40 ppm or more, still more preferably 50 ppm or more, and yet still more preferably 60 ppm or more. From the viewpoint of further reducing the risk of the starting point of breakage due to calcium in the second polyolefin-based resin layer to provide more preferable strength, and/or from the viewpoint of more satisfactorily suppressing the leaching of calcium through the first polyolefin-based resin layer when the first polyolefin-based resin layer is thin, the upper limit of the calcium concentration in the polyolefin-based resin composition used for the second polyolefin-based resin layer is preferably 150 ppm or less, more preferably 130 ppm or less, still more preferably 100 ppm or less, yet still more preferably 90 ppm or less, even yet still more preferably 80 ppm or less, and particularly preferably 85 ppm or less. Therefore, the specific range of the calcium concentration in the polyolefin-based resin composition used for the second polyolefin-based resin layer is 20 to 200 ppm, 20 to 150 ppm, 20 to 130 ppm, 20 to 100 ppm, 20 to 90 ppm, 20 to 80 ppm, 20 to 85 ppm, 30 to 200 ppm, 30 to 150 ppm, 30 to 130 ppm, 30 to 100 ppm, 30 to 90 ppm, 30 to 80 ppm, 30 to 85 ppm, 40 to 200 ppm, 40 to 150 ppm, 40 to 130 ppm, 40 to 100 ppm, 40 to 90 ppm, 40 to 80 ppm, 40 to 85 ppm, 50 to 200 ppm, 50 to 150 ppm, 50 to 130 ppm, 50 to 100 ppm, 50 to 90 ppm, 50 to 80 ppm, 50 to 85 ppm, 60 to 200 ppm, 60 to 150 ppm, 60 to 130 ppm, 60 to 100 ppm, 60 to 90 ppm, 60 to 80 ppm, and 60 to 85 ppm.

The second polyolefin-based resin layer preferably contains an antioxidant. Examples of the antioxidant include phenolic antioxidants, phosphorus-based antioxidants, sulfur-based antioxidants, aromatic amine-based antioxidants, and lactone-based antioxidants. The content of the antioxidant in the second polyolefin-based resin layer is, for example, 0.01% by weight or more, and preferably 0.1% by weight or more, from the viewpoint of suppressing the influence of oxygen to secure preferable strength, and the upper limit of the content of the antioxidant is, for example, 5% by weight or less, preferably 1% by weight or less, and more preferably 0.5% by weight or less.

[4. Gas Barrier Layer]

The gas barrier layer is provided on the outer side of the second polyolefin-based resin layer. The gas barrier layer prevents oxygen from the outer surface of the piping for ultra-pure water from permeating into the second polyolefin-based resin layer and further into the first polyolefin-based resin layer, whereby the strength of the piping for ultra-pure water can be increased. It is also preferable to provide the gas barrier layer in that the dissolution of a gas in the ultra-pure water can also be satisfactorily suppressed.

Examples of the material used for the gas barrier layer include polyvinyl alcohol (PVA), an ethylene vinyl alcohol copolymer (EVOH), a polyvinylidene chloride resin (PVDC), and polyacrylonitrile (PAN), and preferable examples thereof include polyvinyl alcohol (PVA) and an ethylene vinyl alcohol copolymer (EVOH).

The thickness of the gas barrier layer is not particularly limited as long as at least gas barrier property which suppresses the decrease in the strength due to the oxidative deterioration of the polyolefin-based resin can be secured, but it is, for example, 50 to 300 μm, preferably 100 to 250 μm, and more preferably 150 to 250 μm.

[5. Applications of Piping for Ultra-Pure Water]

The piping for ultra-pure water of the present invention is used to convey ultra-pure water. Specifically, the piping for ultra-pure water of the present invention can be used as a piping in an ultra-pure water manufacturing device, a piping for conveying ultra-pure water from the ultra-pure water manufacturing device to use points, and a piping for returning ultra-pure water from the use points, and the like.

The piping for ultra-pure water of the present invention is preferably a water piping for nuclear power generation which requires particularly strict water quality for ultra-pure water, or a convey piping for ultra-pure water used in a wet treatment process such as cleaning in a pharmaceutical product manufacturing process, or a semiconductor element or liquid crystal manufacturing process, and more preferably a semiconductor element manufacturing process. The semiconductor element preferably has a higher degree of integration. More specifically, the semiconductor element is more preferably used in the manufacturing process of a semiconductor element having a minimum line width of 65 nm or less. Examples of standards for the quality and the like of ultra-pure water used in semiconductor manufacture include SEMI F75.

Since the piping for ultra-pure water of the present invention is made of the polyolefin-based resin, it has excellent workability. For example, at relatively low temperatures, fusion working such as butt fusion bonding or EF (electric fusion) bonding can be easily performed.

[6. Manufacture of Piping for Ultra-Pure Water]

The piping for ultra-pure water of the present invention can be manufactured by preparing a polyolefin-based resin composition used for a first polyolefin-based resin layer, a polyolefin-based resin composition used for a second polyolefin-based resin layer, and a resin composition constituting a gas barrier layer if necessary, and coextrusion-molding the resin compositions so that the thickness of each layer in the piping for ultra-pure water is a predetermined thickness. Since the piping for ultra-pure water of the present invention is made of the polyolefin-based resin, it can be manufactured at low cost.

Both the polyolefin-based resins used for the first polyolefin-based resin layer and the second polyolefin-based resin layer can be synthesized by polymerization due to a chlorine-based catalyst such as a widely used Ziegler-Natta catalyst (catalyst including triethylaluminum and titanium tetrachloride).

The calcium concentration in the polyolefin-based resin composition used for each polyolefin-based resin layer is directly controlled by adjusting the amount of a neutralizing agent to be added after polymerization. Since the amount of the neutralizing agent is influenced by the amount of the chlorine-based catalyst, the calcium concentration can also be indirectly controlled by adjusting the amount of the chlorine-based catalyst. The molecular weight distribution (Mw/Mn) in the polyolefin-based resin layer can be controlled by adjusting the amount of the chlorine-based catalyst and/or a polymerization process (one-stage polymerization or multi-stage polymerization such as two-stage or more polymerization). For example, when the amount of the chlorine-based catalyst is increased, the molecular weight distribution (Mw/Mn) tends to increase. The multi-stage polymerization such as two-stage or more polymerization can provide the increase in the molecular weight distribution (Mw/Mn).

More specifically, the polyolefin-based resin used for the first polyolefin-based resin layer is subjected to one-stage polymerization using, for example, a chlorine-based catalyst in an amount appropriately determined by those skilled in the art, and a neutralizing agent (for example, calcium stearate or hydrocalcite or the like) is then added in an amount of 10 ppm or less in terms of calcium concentration. One of the neutralizing agents to be added may be used alone, or two or more thereof may be used in combination. Alternatively, the neutralizing agent may not be added. The polyolefin-based resin constituting the first polyolefin-based resin layer may be polymerized using a polymerization catalyst other than the above chlorine-based catalyst, for example, a chromium-based catalyst or a metallocene catalyst. In this case, it is not necessary to add the neutralizing agent.

The polyolefin-based resin used for the second polyolefin-based resin layer is subjected to multi-stage polymerization, and preferably two-stage polymerization, using a chlorine-based catalyst in an amount appropriately determined by those skilled in the art. The neutralizing agent (for example, calcium stearate or hydrocalcite or the like) is then added in an amount of 20 to 200 ppm in terms of calcium concentration, and an antioxidant is also preferably added in combination.

### EXAMPLES

Hereinafter, the present invention will be described in more detail with reference to Examples, but the present invention is not limited to these Examples.

(1) Production of Piping for Ultra-Pure Water

As a polyolefin for a first polyolefin-based resin layer (first PO layer) and a second polyolefin-based resin layer (second PO layer), resins shown in Tables 1 and 2 were used. In Tables, HDPE represents high density polyethylene, and rPP represents random polypropylene. Each of resins was synthesized by one-stage polymerization or two-stage polymerization using a catalyst containing titanium tetrachloride, and a neutralizing agent was added so as to provide calcium concentrations shown in Tables. Except for Comparative Example 2, an antioxidant was added to the polyolefin for the second polyolefin-based resin layer. An ethylene vinyl alcohol copolymer was used as a resin for a gas barrier layer.

Resin compositions were coextrusion-molded so as to provide thicknesses and SDRs shown in Tables 1 and 2 in a piping for ultra-pure water. In Comparative Example 2, a single-layer tube was molded, and in Examples 1 to 9 and Comparative Examples 1 and 3 to 5, multi-layer tubes were molded. The thickness of the gas barrier layer was 200 μm, and the outer diameter thereof was 60 mm.

(2) Weight Average Molecular Weight Mw, Number Average Molecular Weight Mn, and Mw/Mn

The weight average molecular weight Mw, the number average molecular weight Mn, and the Mw/Mn were measured by gel permeation chromatography (GPC). HLC-8121GPCYHT manufactured by TOSHO was used as a GPC device; three TSKgeIGMHHR-H (20) and one TSKguardcolumn-HHR (30) were used as columns; and a differential refractometer (RI detector) was used as a detector, to perform measurement. o-dichlorobenzene was used as a measurement solvent, and a column temperature was set to 140° C. A concentration of a sample was set to 0.1 wt/vol %. A molecular weight calibration curve was produced by a universal calibration method, using a polystyrene sample having a known molecular weight.

(3) Evaluation of Performance

(3-1) Measurement of Leaching Amount of Organic Components (TOC) and Leaching Amount of Calcium

A test sample was obtained by cutting the obtained piping for ultra-pure water to a length of 200 mm, enclosing ultra-pure water therein, and plugging both the ends with polytetrafluoroethylene (PTFE), followed by wire fixing from the outside. Ultra-pure water was used which had a TOC amount and a calcium concentration equal to or less than the detection limit of a measuring device. The test sample was allowed to stand at 85° C.±5° C. for 7 days for leaching. After leaching, the amounts ofTOC and calcium in the water in the test sample were respectively measured using a TOC meter (model number: ICS2000 manufactured by Thermo Fisher Scientific K.K.) and an iSP-MS device (model number: Agirent 7500cs manufactured by Agilent Technologies). A reference value to be satisfied for the leaching amount of the organic components (TOC) was 60000 μg/m² or less based on the SEMI F57 standard, and a reference value to be satisfied for the leaching amount of calcium was 30 μg/m² or less based on the SEMI F57 standard. The results are shown in Tables 1 and 2.

(3-2) Measurement of Strength (Internal Pressure Creep Performance)

A piping for ultra-pure water having an outer diameter of 60 mm was cut to a length of 300 mm, and both ends thereof were sealed with a metal fixing jig to obtain a test sample. According to the internal pressure creep test method described in JIS K6761, a time for rupture was measured to derive a useful life. A reference value to be satisfied for the useful life derived from the internal pressure creep performance test was set to 30 years or more which was practically required. The results are shown in Tables 1 and 2.

TABLE 1

| | | Examples | | | | | | | | |
|---|---|---|---|---|---|---|---|---|---|---|
| | | 1 | 2 | 3 | 4 | 5 | 6 | 7 | 8 | 9 |
| First PO | Material | HDPE | rPP | HDPE | HDPE | HDPE | HDPE | HDPE | HDPE | HDPE |
| layer | n-stage polymerization | 1 | 2 | 1 | 1 | 2 | 2 | 1 | 1 | 1 |
| | Mw (× 10⁵) | 2.7 | 7.4 | 2.7 | 2.7 | 6.0 | 6.0 | 2.7 | 2.7 | 2.7 |
| | Mw/Mn | 4.9 | 8.7 | 4.9 | 4.9 | 23.8 | 23.8 | 4.9 | 4.9 | 4.9 |
| | Calcium concentration (ppm) | 0.8 | 0.8 | 0.8 | 0.8 | 9 | 9 | 0.8 | 0.8 | 0.8 |
| | Thickness (μm) | 1 | 1 | 1 | 2.5 | 1 | 1 | 2.5 | 0.5 | 2.5 |
| Second PO | Material | HDPE | rPP | HDPE | HDPE | HDPE | HDPE | HDPE | HDPE | HDPE |
| layer | n-stage polymerization | 2 | 2 | 2 | 2 | 2 | 2 | 2 | 2 | 2 |
| | Mw (× 10⁵) | 6.0 | 7.4 | 6.0 | 6.0 | 6.0 | 6.0 | 6.0 | 6.0 | 6.0 |
| | Mw/Mn | 23.8 | 8.7 | 23.8 | 23.8 | 23.8 | 23.8 | 23.8 | 23.8 | 23.8 |
| | Calcium concentration (ppm) | 70 | 70 | 70 | 30 | 70 | 30 | 70 | 200 | 30 |
| Presence or absence of gas barrier layer | | Presence | Presence | Absence | Absence | Absence | Absence | Absence | Presence | Absence |
| SDR | | 11 | 11 | 11 | 17 | 11 | 11 | 17 | 11 | 20 |
| Performance | Leaching of organic components | 840 | 13000 | 810 | 800 | 40000 | 35000 | 800 | 48000 | 800 |
| | (TOC) (μg/m²) | | | | | | | | | |
| | Leaching of calcium (μg/m²) | 11 | 16 | 11 | 13 | 25 | 25 | 13 | 28 | 13 |
| | Internal pressure creep performance | 60 years | 60 years | 50 years | 35 years | 60 years | 40 years | 40 years | 60 years | 30 years |
| | (internal pressure: 1 MPa, 23° C.) | | | | | | | | | |

TABLE 2

| | | Comparative Examples | | | | |
|---|---|---|---|---|---|---|
| | | 1 | 2 | 3 | 4 | 5 |
| First PO | Material | HDPE | HDPE | HDPE | HDPE | HDPE |
| layer | n-stage polymerization | 2 | 1 | 1 | 1 | 2 |
| | Mw (× 10⁵) | 6.0 | 2.7 | 2.7 | 2.7 | 6.0 |
| | Mw/Mn | 23.8 | 4.9 | 4.9 | 4.9 | 23.8 |
| | Calcium concentration (ppm) | 1.5 | 0.8 | 0.8 | 0.8 | 9 |
| | Thickness (μm) | 1 | (Single | 0.5 | 2.5 | 1 |
| | | | layer) | | | |
| Second PO | Material | HDPE | — | HDPE | HDPE | HDPE |
| layer | n-stage polymerization | 2 | — | 2 | 2 | 2 |
| | Mw (× 10⁵) | 6.0 | — | 6.0 | 6.0 | 6.0 |
| | Mw/Mn | 23.8 | — | 23.8 | 23.8 | 23.8 |
| | Calcium concentration (ppm) | 70 | — | 250 | 15 | 15 |
| Presence or absence of gas barrier layer | | Presence | Absence | Presence | Absence | Presence |
| SDR | | 11 | 11 | 11 | 17 | 11 |
| Performance | Leaching of organic components | 62000 | 800 | 66000 | 800 | 35000 |
| | (TOC) (μg/m²) | | | | | |
| | Leaching of calcium (μg/m²) | 65 | 13 | 85 | 20 | 25 |
| | Internal pressure creep performance | 60 years | 5 years | 20 years | 20 years | 20 years |
| | (internal pressure: 1 MPa, 23° C.) | | | | | |

As shown in the above Tables, when the calcium concentration in the polyolefin-based resin composition used for the first polyolefin-based resin layer exceeded 10 ppm (Comparative Example 1), the amount of calcium leaching into the ultra-pure water was excessive. Therefore, the water quality required for the ultra-pure water could not be satisfied. When the calcium concentration in the polyolefin-based resin composition used for the first polyolefin-based resin layer was reduced to 10 ppm or less (Comparative Examples 2, 4, and 5), the amount of calcium leaching into the ultra-pure water was suppressed. Therefore, the water quality required for the ultra-pure water could be satisfied. However, when the piping for ultra-pure water itself was composed of a single layer (Comparative Example 2) and even if the piping for ultra-pure water itself was composed of a multiple layer, the calcium concentration in the polyolefin-based resin composition used for the second polyolefin-based resin layer was less than 20 ppm, so that mechanical strength required for practical use could not be satisfied. Even if the calcium concentration in the polyolefin-based resin composition used for the second polyolefin-based resin layer exceeded 200 ppm (Comparative Example 3), the mechanical strength required for practical use could not be satisfied. Furthermore, when the calcium concentration in the polyolefin-based resin composition used for the second polyolefin-based resin layer exceeded 20 ppm (Comparative Example 3), and the first polyolefin-based resin layer was thin, calcium in the second polyolefin-based resin layer migrated through the first polyolefin-based resin layer, and excessively leached into the ultra-pure water. Therefore, the water quality required for the ultra-pure water could not be satisfied.

Meanwhile, when the calcium concentration in the polyolefin-based resin composition used for the first polyolefin-based resin layer was 10 ppm or less, and the calcium concentration in the polyolefin-based resin composition used for the second polyolefin-based resin layer was 20 ppm or more and 200 ppm or less (Examples 1 to 8), the amount of calcium leaching into the ultra-pure water was suppressed. Therefore, the water quality required for the ultra-pure water could be satisfied, and the mechanical strength required for practical use could also be satisfied. In view of the levels of the leaching amount of calcium and the leaching amount of organic components (TOC), the pipings for ultra-pure water of Examples 1 to 8 were observed to be suitable for conveying a semiconductor cleaning solution suitable for a wet treatment process of a semiconductor element having a minimum line width of 65 nm or less.

As shown in comparison between Example 1 and Example 2, when the polyethylene-based resin was used for the first polyolefin-based resin layer (Example 1), the amounts of calcium and TOC leaching into the ultra-pure water were further suppressed.

As shown in comparison between Example 1 and Example 3, when the gas barrier layer was provided on the outer side of the second polyolefin-based resin layer (Example 1), the oxidative deterioration of the polyolefin-based resin due to oxygen from the outer surface of the ultra-pure water was suppressed, whereby more preferable strength could be obtained.

As shown in comparison between Example 3 and Example 5 and comparison between Example 4 and Example 6, when a molecular weight distribution Mw/Mn in the first polyolefin-based resin layer was 2 to 20 (Examples 3 and 4), the amount of TOC leaching into the ultra-pure water was further suppressed. On the other hand, as shown in comparison between Example 3 and Example 5, as the overlap of the molecular weight distributions of the first polyolefin-based resin and the second polyolefin-based resin was greater (Example 5), adhesion between the layers was improved, whereby the strength of the entire piping for ultra-pure water was increased.

As shown in comparison between Examples 1, 3, 4, 7, 9 and Example 8, the thickness of the first polyolefin-based resin layer was 0.8 mm or more, and the calcium concentration in the polyolefin-based resin composition used for the second polyolefin-based resin layer was 150 ppm or less (Examples 1, 3, 4, 7, and 9), the leaching of calcium into the ultra-pure water due to the migration of the calcium concentration contained in the second polyolefin-based resin layer was blocked, whereby the amount of calcium leaching into the ultra-pure water was further suppressed.

As shown in comparison between Example 7 and Example 3, and comparison between Examples 4, 9 and Example 6, when the thickness of the first polyolefin-based resin layer was 2.0 mm or less (Examples 3 and 6), the influence of the lack of the strength of the first polyolefin-based resin layer on the entire piping for ultra-pure water was reduced, whereby more preferable strength of the entire piping for ultra-pure water could be obtained.

As shown in comparison between Example 9 and Examples 4, 6, when SDR was 17 or less (Examples 4 and 6), the relative thickness of the second polyolefin-based resin layer was secured to further compensate for the lack of the strength of the first polyolefin-based resin layer itself, whereby more preferable strength could be obtained.

As shown in Examples 1, 3, 4, 7, and 9, when the weight average molecular weights of the polyolefin-based resins used for the second polyolefin-based resin and the first polyolefin-based resin separated from each other in an extent that the weight average molecular weight of the polyolefin-based resin used for the second polyolefin-based resin layer was 1.5 to 4 times the weight average molecular weight of the polyolefin-based resin used for the first polyolefin-based resin, essentially, the lack of the strength of the entire piping for ultra-pure water due to the lack of the adhesion between the layers disadvantageously tended to occur. However, by setting the molecular weight distribution Mw/Mn in the second polyolefin-based resin layer to 20 to 40, the overlap of the molecular weight distributions of the first polyolefin-based resin and the second polyolefin-based resin was secured, whereby the low molecular weight components between the layers could be secured. This made it possible to sufficiently secure the strength of the entire piping for ultra-pure water.

### DESCRIPTION OF REFERENCE SIGNS

100, 100a, 100b: Piping for ultra-pure water
210, 210a: First polyolefin-based resin layer
220: Second polyolefin-based resin layer
300: Gas barrier layer

1. A piping for ultra-pure water used for conveying ultra-pure water,
the piping for ultra-pure water comprising:
a first polyolefin-based resin layer constituting an innermost layer; and
a second polyolefin-based resin layer disposed on an outer side of the first polyolefin-based resin layer,
wherein a calcium concentration in a polyolefin-based resin composition used for the first polyolefin-based resin layer is 10 ppm or less, and
a calcium concentration in a polyolefin-based resin composition used for the second polyolefin-based resin layer is 20 ppm or more and 200 ppm or less.

2. The piping for ultra-pure water according to claim 1, wherein the polyolefin-based resin composition used for the first polyolefin-based resin layer is a polyethylene-based resin composition.

3. The piping for ultra-pure water according to claim 2, wherein the polyethylene-based resin is high density polyethylene.

4. The piping for ultra-pure water according to claim 1, wherein a molecular weight distribution Mw/Mn in the first polyolefin-based resin layer is 2 to 20.

5. The piping for ultra-pure water according to claim 1, wherein a thickness of the first polyolefin-based resin layer is 0.8 mm or more.

6. The piping for ultra-pure water according to claim 1, wherein a thickness of the first polyolefin-based resin layer is 2.0 mm or less.

7. The piping for ultra-pure water according to claim 1, wherein the piping for ultra-pure water has SDR of 17 or less.

8. The piping for ultra-pure water according to claim 1, wherein
a weight average molecular weight of the polyolefin-based resin used for the second polyolefin-based resin layer is 1.5 to 4 times a weight average molecular weight of the polyolefin-based resin used for the first polyolefin-based resin, and
a molecular weight distribution Mw/Mn in the second polyolefin-based resin layer is 20 to 40.

9. The piping for ultra-pure water according to claim 1, further comprising a gas barrier layer provided on an outer side of the second polyolefin-based resin layer.

10. The piping for ultra-pure water according to claim 1, wherein the ultra-pure water is used in a wet treatment process of a semiconductor element or a liquid crystal.

11. The piping for ultra-pure water according to claim 1, wherein the ultra-pure water is used in a wet treatment process of a semiconductor element having a minimum line width of 65 nm or less.

12. A multi-layer tube comprising:
a first polyolefin-based resin layer constituting an innermost layer; and
a second polyolefin-based resin layer disposed on an outer side of the first polyolefin-based resin layer,
wherein a calcium concentration in a polyolefin-based resin composition used for the first polyolefin-based resin layer is 10 ppm or less, and
a calcium concentration in a polyolefin-based resin composition used for the second polyolefin-based resin layer is 20 ppm or more and 200 ppm or less.
